(19) United States
(12) Patent Application Publication
(10) Pub. No.: US 2025/0384286 A1
(43) Pub. Date: Dec. 18, 2025

(54) METHODS AND SYSTEMS FOR IDENTIFYING AND MITIGATING NEGATIVE BIAS IN LARGE LANGUAGE MODEL

(71) Applicants: SAMSUNG SDS CO., LTD., Seoul (KR); Seoul National University R&DB FOUNDATION, Seoul (KR)

(72) Inventors: Sung Roh YOON, Seoul (KR); Bong Kyu HWANG, Seoul (KR); Ho Young KANG, Seoul (KR); Soo Ah CHO, Seoul (KR); Jun Hwa CHOI, Seoul (KR); Seong Ho JOE, Seoul (KR); Jong Yoon SONG, Seoul (KR); Sang Won YU, Seoul (KR); Young June GWON, Seoul (KR)

(73) Assignees: SAMSUNG SDS CO., LTD., Seoul (KR); Seoul National University R&DB FOUNDATION, Seoul (KR)

(21) Appl. No.: 19/210,874

(22) Filed: May 16, 2025

(30) Foreign Application Priority Data
Jun. 14, 2024 (KR) 10-2024-0077498
Oct. 30, 2024 (KR) 10-2024-0151077

(51) Int. Cl. G06N 3/09; G06N 3/0475

(52) U.S. Cl. CPC G06N 3/09; G06N 3/0475

(57) ABSTRACT

Methods and systems for identifying and mitigating negative bias are provided. The method for identifying negative bias according to some embodiments may include generating a dataset including each of samples including a positive answer or negative answer, inputting each of the samples included in the dataset into a large language model (LLM), and identifying negative bias of the LLM using information output from the LLM. The method for mitigating negative bias according to some embodiments may include selecting one or more attention heads with negative bias from among a plurality of attention heads of LLM and performing a fine-tuning process on the selected one or more attention heads.

### CROSS-REFERENCE TO RELATED APPLICATION

This application claims priority from Korean Patent Application No. 10-2024-0077498 filed on Jun. 14, 2024, and Korean Patent Application No. 10-2024-0151077 filed on Oct. 30, 2024, in the Korean Intellectual Property Office, and all the benefits accruing therefrom under 35 U.S.C. 119, the contents of which in its entirety are herein incorporated by reference.

### BACKGROUND

### 1. Field

The present disclosure relates to methods and systems for identifying and mitigating negative bias in a large language model (LLM).

### 2. Description of the Related Art

Methods for addressing the hallucination problem, in which a large language model (LLM) generates incorrect or false information, are actively being discussed.

For example, in order to address the hallucination problem that arises when an LLM performs tasks requiring short answers or descriptive answers to input questions, the prior knowledge of the LLM or the knowledge processing mechanism in the LLM's reasoning process may be analyzed.

However, due to the diversity of answers that an LLM can generate, fully understanding its characteristics to address the hallucination problem is difficult.

Therefore, a new method is required to solve the hallucination problem of an LLM that occurs in tasks requiring complex reasoning.

### SUMMARY

One objective of the present disclosure is to provide a method for identifying negative bias that occurs when a large language model (LLM) performs a task of determining whether a question is true or false, and a computing system for performing the method.

Another objective of the present disclosure is to provide a method for converting complex reasoning data samples, which include various answers to a question, into binary decision data samples, and a computing system for performing the method.

Yet another objective of the present disclosure is to provide a method for mitigating hallucination in an LLM using a dataset generated based on prior knowledge of the LLM in order to create a more reliable LLM, and a computing system for performing the method.

Still another objective of the present disclosure is to provide a method for selecting is an attention head with negative bias in an LLM and fine-tuning the selected attention head, and a computing system for performing the method.

The objectives of the present disclosure are not limited to those mentioned above, and other objectives not explicitly stated will be clearly understood by those skilled in the art based on the following description.

According to an aspect of the present disclosure, there is provided a method for identifying negative bias performed by a computing system. The method may include converting each of a first plurality of samples, from among samples included in a first dataset, into a positive sample including a positive answer, each of the samples including a question and a label for the question, converting each of a second plurality of samples, which are remaining samples excluding the first plurality of samples, into a negative sample including a negative answer, generating a second dataset including positive samples corresponding to the first plurality of samples and negative samples corresponding to the second plurality of samples, inputting the positive samples and the negative samples included in the second dataset into a first large language model (LLM), the first LLM being a language model configured to generate an answer to the question and identifying negative bias of the first LLM using information output from the first LLM.

In some embodiments, wherein the converting of each of the first plurality of samples into the positive sample including the positive answer may include generating a second question including a first question of a first sample among the first plurality of samples and a first label for the first question and generating a positive sample corresponding to the first sample, the generated positive sample including the second question and the positive answer.

In some embodiments, wherein the converting of each of the second plurality of samples into the negative sample including the negative answer may include generating a corrupted first label, generating a second question including a first question of a first sample among the second plurality of samples and the corrupted first label and generating a negative sample corresponding to the first sample, the generated negative sample including the second question and the negative answer.

In some embodiments, wherein the generating of the corrupted first label may include inputting the first question and a first label of the first sample into a second LLM, the second LLM being a language model configured to generate an answer to the first question that differs from the first label and generating the corrupted first label, which differs from the first label, using information output from the second LLM.

In some embodiments, wherein the identifying of the negative bias of the first LLM using the information output from the first LLM may include acquiring answers corresponding to the respective positive samples and negative samples from the first LLM, calculating a number of answers, among the acquired answers, that do not match the answers of corresponding samples and identifying the negative bias using the calculated number.

According to another aspect of the present disclosure, there is provided a method for mitigating negative bias in a large language model (LLM), performed by a computing system. The method may include acquiring a first dataset including samples, each of the samples including a question and a label for the question, identifying probing samples from among the samples included in the first dataset, the probing samples being samples whose labels match answers obtained by inputting corresponding questions to the LLM, converting each of the probing samples into a positive sample, generating a second dataset including positive samples corresponding to the probing samples, calculating first negative bias attention scores (NASs) of a plurality of attention heads of the LLM for the second dataset, selecting one or more attention heads from among the plurality of attention heads of the LLM using the first NASs and performing a fine-tuning process on the selected one or more attention heads.

In some embodiments, wherein the converting of each of the probing samples into the positive sample may include generating a second question including a first question of a first sample among the probing samples and a first label for the first question and generating a positive sample corresponding to the first sample, the generated positive sample including the second question and a positive answer.

In some embodiments, wherein the calculating of the first NASs of the plurality of attention heads of the LLM for the second dataset may include inputting a prompt corresponding to a first sample among the positive samples included in the second dataset to the LLM, acquiring, from the LLM, attention matrices of the plurality of attention heads for the prompt, each of the attention matrices including attention weight values for respective tokens included in the prompt and calculating first NASs of the plurality of attention heads for the first sample using the attention matrices, the prompt may include a positive token and a negative token, and each of the first NASs may be calculated based on a ratio of an attention weight value for the negative token to an attention weight value for the positive token.

In some embodiments, wherein the calculating of the first NASs of the plurality of attention heads of the LLM for the second dataset may include calculating first NASs of a first attention head among the plurality of attention heads for the respective positive samples included in the second dataset and calculating an average of the calculated first NASs.

In some embodiments, the method may further include dividing the positive samples included in the second dataset into a first sample set and a second sample set, calculating second NASs of the plurality of attention heads of the LLM for the first sample set, calculating an average of the second NASs of the plurality of attention heads, generating a fine-tuning set including a subset of samples included in the second sample set and generating a validation set including remaining samples in the second sample set excluding the subset of samples, wherein the fine-tuning process may be performed using the average of the second NASs, the fine-tuning set, and the validation set.

In some embodiments, wherein the performing of the fine-tuning process on the selected one or more attention heads may include repeatedly updating parameters of a first attention head among the selected one or more attention heads using the fine-tuning set, calculating a third NAS of the first attention head for the validation set, terminating the updating of the parameters of the first attention head if the third NAS is lower than a predefined threshold, calculating an average of third NASs of the plurality of attention heads for the validation set and terminating the fine-tuning process if the average of the third NASs is less than the average of the second NASs.

In some embodiments, wherein the performing of the fine-tuning process on the selected one or more attention heads may include in a first iteration, updating parameters of a first attention head among the selected one or more attention heads using the fine-tuning set, calculating a third NAS of the updated first attention head for the validation set, and calculating an average of third NASs of the plurality of attention heads for the validation set, in a second iteration after the first iteration, re-updating the parameters of the updated first attention head using the fine-tuning set, calculating a fourth NAS of the re-updated first attention head for the validation set, and calculating an average of fourth NASs of the plurality of attention heads for the validation set and updating parameters of a second attention head among the selected one or more attention heads if the fourth NAS of the re-updated first attention head is higher than or equal to the third NAS of the updated first attention head or the average of the fourth NASs of the plurality of attention heads is greater than or equal to the average of the third NASs of the plurality of attention heads.

According to yet another aspect of the present disclosure, there is provided a system for identifying negative bias. The system may include at least one processor and at least one memory storing instructions which, when executed by the at least one processor, cause the at least one processor to perform operations, wherein the operations may include converting each of a first plurality of samples, from among samples included in a first dataset, into a positive sample including a positive answer, each of the samples including a question and a label for the question, converting each of a second plurality of samples, which are remaining samples excluding the first plurality of samples, into a negative sample including a negative answer, generating a second dataset including positive samples corresponding to the first plurality of samples and negative samples corresponding to the second plurality of samples, inputting the positive samples and the negative samples included in the second dataset into a first large language model (LLM), the first LLM being a language model configured to generate an answer to the question and identifying negative bias of the first LLM using information output from the first LLM.

According to yet another aspect of the present disclosure, there is provided a system for mitigating negative bias. The system may include at least one processor and at least one memory storing instructions which, when executed by the at least one processor, cause the at least one processor to perform operations, wherein the operations may include acquiring a first dataset including samples, each of the samples including a question and a label for the question, identifying probing samples from among the samples included in the first dataset, the probing samples being samples whose labels match answers obtained by inputting corresponding questions to a large language model (LLM), converting each of the probing samples into a positive sample, generating a second dataset including positive samples corresponding to the probing samples, calculating first negative bias attention scores (NASs) of a plurality of attention heads of the LLM for the second dataset, selecting one or more attention heads from among the plurality of attention heads of the LLM using the first NASs; and performing a fine-tuning process on the selected one or more attention heads.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a block diagram illustrating an example of a large language model (LLM) system according to an embodiment of the present disclosure;

FIG. 2 is a diagram for explaining an LLM according to one embodiment of the present disclosure;

FIG. 3 is a flowchart illustrating the overall operation of a negative bias management system according to one embodiment of the present disclosure;

FIG. 4 is a flowchart illustrating a process of identifying negative bias according to one embodiment of the present disclosure;

FIG. 5 is a flowchart illustrating a process of detecting an attention head with negative bias according to some embodiments of the present disclosure;
FIG. 6 is a diagram for explaining a probing dataset according to some embodiments of the present disclosure;

FIG. 7 is a diagram for explaining attention heads according to some embodiments of the present disclosure;

FIG. 8 is a diagram for explaining attention weights applied to tokens included in a prompt input to an LLM according to some embodiments of the present disclosure;

FIG. 9 is a flowchart illustrating a process of generating data to be used for fine-tuning an attention head with negative bias according to some embodiments of the present disclosure;

FIG. 10 is a flowchart illustrating a process of fine-tuning an attention head with negative bias according to some embodiments of the present disclosure; and

FIG. 11 is a block diagram illustrating an example of a computing device for performing some embodiments of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In describing this disclosure, specific descriptions of relevant disclosed configurations or features are omitted where it is believed that such detailed descriptions would obscure the essence of the invention.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure.

In this specification, the singular also includes the plural unless specifically stated otherwise in the phrase.

The terms used in the present disclosure are merely for describing specific embodiments and are not intended to limit the features, components, or sequences described in the specification. The terms “comprises” and/or “comprising” as used in the present disclosure indicate the presence of the features, components, steps, operations, and/or combinations thereof described in the specification, but do not preclude the presence or addition of one or more other features, components, steps, operations, and/or combinations thereof.

In addition, in describing the component of the present disclosure, terms, such as first, second, A, B, (a), (b), may be used. These terms are only for distinguishing the components from other components, and the nature or order of the components is not limited by the terms.

In the following embodiments, components described with reference to terms such as “part,” “unit,” “module,” “block,” or other similar terms used in the following descriptions and depicted as functional blocks in the accompanying drawings can be implemented as software, hardware, or a combination thereof. The software may include, for example, machine code, firmware, embedded code, and application software. Additionally, the hardware may include, for example, electrical circuits, electronic circuits, processors, computers, integrated circuits, integrated circuit cores, passive elements, or combinations thereof.

In the present disclosure, “/“and”,” should be interpreted as representing “and/or.” For example, “A/B” and “A, B” may mean “A and/or B.”

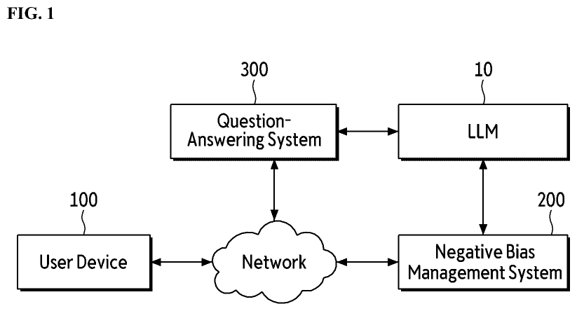

FIG. 1 is a block diagram illustrating an example of a large language model (LLM) system according to an embodiment of the present disclosure.

The LLM system of FIG. 1 may provide a framework for providing a question-answering service according to embodiments of the present disclosure. For example, the LLM system may provide a framework for fine-tuning an LLM according to some embodiments of the present disclosure and providing a service of generating an answer to a specific question using the fine-tuned LLM.

Referring to FIG. 1, the LLM system may include a user device 100, a negative bias management system 200, a question-answering system 300, and/or an LLM 10.

The user device 100 may include various devices used by a user to transmit and receive various data and/or information through communication with other devices. The user device 100 may include a smartphone, tablet PC, laptop, or the like, but is not limited thereto. For example, the user device 100 may include various computing devices equipped with wireless communication means and/or processing means. The user device 100 may also be referred to as a user terminal, wireless device, mobile terminal, portable device, or the like.

In the present disclosure, the user may refer to a user who uses the LLM 10 according to some embodiments of the present disclosure. For example, the user may input a specific question through the user device 100 and check an answer to the specific question generated by the LLM 10.

The user device 100 may be used to utilize the question-answering system 300. For example, the user device 100 may transmit a user input corresponding to a specific question to the question-answering system 300 and receive an answer to the specific question generated by the LLM 10 from the question-answering system 300.

Additionally, the user device 100 may display a user interface for an application in which functions of the question-answering system 300 are implemented.

The LLM 10, which is a generative artificial intelligence (AI)-based language model trained on various types of text, is capable of generating an answer to an input question. In the present disclosure, the LLM 10 may also be referred to as a generative AI model, a question-answering model, a conversational model, or the like.

The negative bias management system 200 may manage the negative bias of the LLM 10 by performing methods and/or operations according to embodiments of the present disclosure.

In the present disclosure, negative bias may refer to a type of hallucination of the LLM 10, and may indicate a bias toward generating a negative answer to an input question when the LLM 10 performs a task of determining whether the input question is true or false.

The negative bias management system 200 may identify negative bias in the LLM 10 according to some embodiments of the present disclosure. For example, the negative bias management system 200 may convert a complex reasoning dataset into a binary decision dataset and identify negative bias in the LLM 10 using the binary decision dataset.

The complex reasoning dataset may refer to a set of complex reasoning data samples. The complex reasoning data samples may each include a question and a label for the question, and the complex reasoning dataset may include various types of answers to a specific question. In other words, the complex reasoning data samples may include different labels as answers to the same question.

In the present disclosure, a label may indicate an answer to a specific question, and may be referred to as an answer, a correct answer, a label, or a ground-truth label.

The binary decision dataset may refer to a set of binary decision data samples. The binary decision data samples may each include a question and an answer to the question, and the answers of the binary decision data samples may be either positive (e.g., “YES”) or negative (e.g., “NO”).

In the present disclosure, a sample including a positive answer may be referred to as a positive sample, and a sample including a negative answer may be referred to as a negative sample. However, in some embodiments of the present disclosure, even if different samples are all referred to as positive samples or negative samples, their respective questions may be different.

For example, in the following description, a positive sample corresponding to a binary decision data sample converted from a complex reasoning data sample and a positive sample corresponding to a probing sample identified from a question-answering sample may refer to different samples including different questions.

In the present disclosure, converting a complex reasoning dataset/sample into a binary decision dataset/sample may refer to generating a binary decision dataset/sample corresponding to the complex reasoning dataset/sample.

For example, the negative bias management system 200 may generate a new question including the question and label of a complex reasoning data sample, and may generate a binary decision data sample including the generated question and a positive answer (e.g., “YES”) as an answer to the generated question.

In another example, the negative bias management system 200 may generate a new corrupted label different from the label for the question of a complex reasoning data sample, generate a new question including the question of the complex reasoning data sample and the corrupted label, and generate a binary decision data sample including the generated question and a negative answer (e.g., “NO”) as an answer to the generated question.

The negative bias management system 200 may generate a binary decision dataset requiring complex reasoning according to some embodiments of the present disclosure, input positive samples and negative samples included in the generated binary decision dataset to the LLM 10, and identify negative bias of the LLM 10 using information output by the LLM 10.

Through this, the negative bias management system 200 may identify and analyze negative bias that occurs when the LLM 10 performs a task of determining whether a specific question is true or false.

The negative bias management system 200 may, according to some embodiments of the present disclosure, detect an attention head with negative bias in the LLM 10 in which negative bias has been identified, and perform fine-tuning on the attention head with negative bias to improve hallucination in the LLM 10.

For example, the negative bias management system 200 may calculate the negative bias attention scores (NASs) of a plurality of attention heads of the LLM 10 with respect to a probing dataset and detect/select an attention head with negative bias from among the plurality of attention heads using the calculated NASs.

Here, the probing dataset may include probing samples for which the LLM 10 knows the “correct answers” to their respective questions.

For example, the negative bias management system 200 may obtain question-answering samples composed of questions and labels to the questions as a question-answering dataset, and identify, as the probing samples, question-answering samples whose labels match the answers obtained by inputting their corresponding questions to the LLM 10.

That is, the negative bias management system 200 may generate the probing dataset based on the prior knowledge of the LLM 10.

A question-answering dataset may refer to a set of question-answering samples. The question-answering samples may each include a question and a label for the question, and the question-answering dataset may include various answers to a specific question. In other words, the question-answering samples may include different labels as answers to the same question.

The probing dataset, as a set of probing samples, may include probing samples converted into positive samples according to some embodiments of the present disclosure.

The probing samples may each include a question and an answer to the question, and the answer of each probing sample converted into a positive sample may include a positive answer (e.g., “YES”).

The negative bias management system 200 may identify probing samples from among the question-answering samples included in the question-answering dataset and convert the identified probing samples into positive samples.

In the present disclosure, converting a probing sample into a positive sample may refer to generating a positive sample corresponding to the probing sample.

For example, the negative bias management system 200 may generate a new question including the question and label of a probing sample, and generate a positive sample including the generated question and a positive answer (e.g., “YES”) as an answer to the generated question.

The negative bias management system 200 may generate a fine-tuning set for fine-tuning the LLM 10 in which negative bias has been identified and a validation set for verifying the fine-tuned LLM 10 using the probing dataset, and fine-tune the attention head of the LLM 10 with negative bias using the fine-tuning set and the validation set.

The negative bias management system 200 may be implemented on at least one computing device. For example, all functions of the negative bias management system 200 may be implemented on a single computing device. In another example, some functions of the negative bias management system 200 may be implemented on a first computing device and other functions may be implemented on a second computing device. Furthermore, a certain function of the negative bias management system 200 may be implemented on one or more computing devices. In yet another example, the negative bias management system 200 may be implemented using a physical server.

For example, the negative bias management system 200 may include a negative bias identification system and/or a negative bias mitigation system. The negative bias identification system may perform methods and/or operations for identifying negative bias in the LLM 10 according to some embodiments of the present disclosure, and the negative bias mitigation system may perform methods and/or operations for detecting/selecting attention heads having negative bias in the LLM 10 in which negative bias has been identified and mitigating the negative bias according to some embodiments of the present disclosure.

Additionally, although not illustrated in FIG. 1, the negative bias management system may further include a database, and may perform the methods and/or operations according to embodiments of the present disclosure using the data (e.g., the complex reasoning dataset, the question-answering dataset, etc.) included in the database.

The question-answering system 300 may provide a question-answering service using the LLM 10 fine-tuned by the negative bias management system 200. For example, the question-answering system 300 may receive a user input for a question from the user device 100, generate a prompt corresponding to the question, input the generated prompt to the LLM 10, acquire an answer to the question output from the LLM 10, and transmit the acquired answer to the user device 100.

The components illustrated in FIG. 1 may communicate through various types of wired/wireless networks. Devices and/or systems according to the present disclosure may be applicable to a communication system such as a local area network (LAN), a wide area network (WAN), a mobile radio communication network, or Wireless Broadband Internet (WiBro), but are not limited thereto and may be applicable to any other communication system.

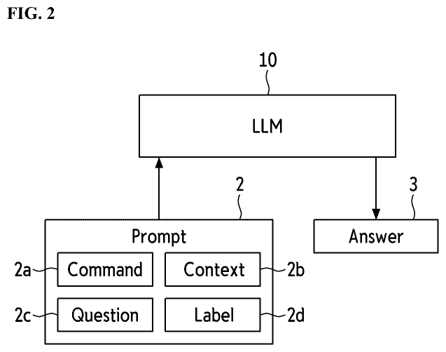

FIG. 2 is a diagram for explaining the LLM 10 according to an embodiment of the present disclosure.

Referring to FIG. 2, a prompt 2 may be input to the LLM 10, and the LLM 10 may generate an answer 3 in answer to the prompt 2.

The LLM 10 is assumed to be a language model including a decoder that autoregressively generates the answer 3 based on the prompt 2.

When the LLM 10 is denoted as P_{ϕ}, the prompt 2 as Pt, and the answer 3 as R, and Pt={p₁, . . . , p_{M}} is input to the LLM 10, the LLM 10 may autoregressively generate the answer 3 as R={r₁, . . . , rₙ}. In this case, the LLM 10 selects rₙ as an n-th answer token based on a probability distribution P_{ϕ}(rₙ|P₁, . . . , P_{M}>r₁>r_{<n})

For example, when the LLM 10 is required to generate one of a positive answer (e.g., “YES”) or a negative answer (e.g., “NO”) as the answer 3, the LLM 10 generates the answer 3 by considering the probability values of vocabularies related to the positive and negative answers.

The prompt 2 may include a command 2a, context 2b, question 2c, and/or label 2d, and is not limited to necessarily including the command 2a, the context 2b, and/or the label 2d.

The command 2a may include information that restricts the scope of the answer 3 to be generated by the LLM 10 and may be prompted to the LLM 10 together with the question 2c. For example, in order to limit the answer 3 to either a positive answer {“YES”} or a negative answer {“NO”}, a command 2a in the form of {“ . . . You MUST answer Yes or No . . . ”} may be prompted to the LLM 10 together with the question 2c.

In the present disclosure, when the command 2a is included in the prompt 2, unless otherwise stated, it is assumed that the command 2a is located to the left or before the context 2b, the question 2c, and/or the label 2d.

The context 2b may be generated in answer to the question 2c and/or the label 2d and may include information serving as a basis for the LLM 10 to generate the answer 3 in answer to the prompt 2.

The label 2d refers to an answer to the question 2c. According to some embodiments of the present disclosure, a new question including the question 2c and the label 2d may be generated, and the generated new question may be included in the prompt 2 and input to the LLM 10.

Additionally, although not illustrated in FIG. 2, according to some embodiments of the present disclosure, a corrupted answer may be generated in answer to the question 2c and/or s the label 2d. A new question including the question 2c and the corrupted answer may be generated, and the generated new question may be included in the prompt 2 and input to the LLM 10.

In the present disclosure, the question 2c included in the prompt 2 and the corresponding label 2d or corrupted label may be collectively referred to as a question prompt. In other words, according to some embodiments of the present disclosure, when a new question including the question 2c and the label 2d is generated, or a new question including the question 2c and the corrupted label is generated, the generated new question may be referred to as a question prompt.

The answer 3 may be generated in answer to the question 2c included in the prompt 2 and/or a newly generated question according to some embodiments of the present disclosure (e.g., a question of a binary decision data sample or a question of a probing sample converted into a positive sample).

Additionally, the answer 3 may be generated in various forms for the same or different questions, but may be restricted in form depending on the command 2a. For example, when the prompt 2 includes a command 2a giving instructions to respond with either a positive answer (e.g., “YES”) or a negative answer (e.g., “NO”), the answer 3 to the question 2c from the LLM 10 may be the positive answer (e.g., “YES”) or the negative answer (e.g., “NO”).

For example, when a prompt 2 including the question 2c is input to the LLM 10, the label 2d or various answers different from the label 2d may be acquired as the answer 3 to the question 2c from the LLM 10.

In another example, when a question included in a positive sample (e.g., a positive sample corresponding to a binary decision data sample or a probing sample) that includes a generated question 2c and label 2d is input to the LLM 10 as the prompt 2, a positive answer (e.g., “YES”) or a negative answer (e.g., “NO”) may be acquired from the LLM 10 as the answer 3 to the new question.

In yet another example, when a question included in a negative sample (e.g., a negative sample corresponding to a binary decision data sample) that includes a generated question 2c and corrupted label is input to the LLM 10 as the prompt 2, a positive answer (e.g., “YES”) or a negative answer (e.g., “NO”) may be acquired from the LLM 10 as the answer 3 to the new question.

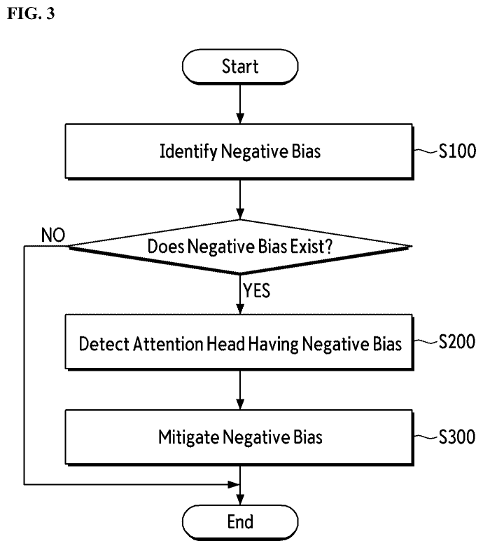

Embodiments of a computing system for identifying and mitigating negative bias according to the present disclosure will hereinafter be described in detail with reference to FIGS. 3 through 11. It is to be noted that FIGS. 3 through 11 illustrate steps/operations performed by the negative bias management system 200. Therefore, in the following description, when the subject of a specific step or operation is omitted, the specific step or operation may be understood to be performed by the negative bias management system 200. FIGS. 1 and 2 will also be referenced along with FIGS. 3 through 11.

Additionally, it is to be noted that the technical ideas understood from the embodiments described with reference to FIGS. 1 and 2 may obviously be applicable to methods according to embodiments to be described with reference to FIGS. 3 through 9, even if not explicitly stated.

FIG. 3 is a flowchart illustrating the overall operation of the negative bias management system 200 according to an embodiment of the present disclosure.

Referring to FIG. 3, first, negative bias may be identified in the LLM 10 (S100). As described earlier with reference to FIG. 2, the LLM 10 may include a plurality of attention heads. In step S100, when negative bias is identified, at least one of the attention heads of the LLM 10 may have negative bias.

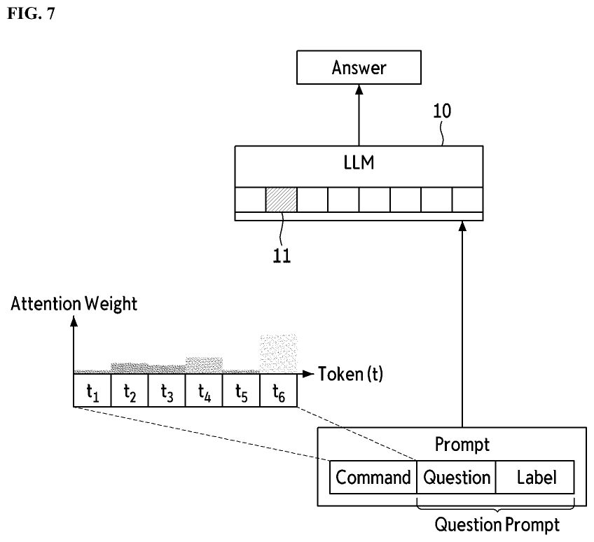

The attention heads, which are modules that assign an attention weight to the tokens included in the prompt 2 input to the LLM 10, may exhibit negative bias by assigning a greater attention weight to negative tokens than to positive tokens among the tokens included in the prompt 2. A specific embodiment of the attention heads will be described later with reference to FIG. 7.

According to some embodiments of the present disclosure, negative bias may be detected by focusing on the parameters of the LLM 10 through detection of one or more attention heads with negative bias among the attention heads included in the LLM 10.

In addition, according to some embodiments of the present disclosure, negative bias may be mitigated by performing fine-tuning on the attention head with negative bias to conduct a minimal update of the parameters of the LLM 10.

In step S200, an attention head with negative bias may be detected from among the attention heads of the LLM 10 in which negative bias has been identified.

In step S300, the negative bias of the LLM 10 may be mitigated. For example, by fine-tuning the attention head with negative bias detected in S200, the negative bias of the LLM 10 may be mitigated.

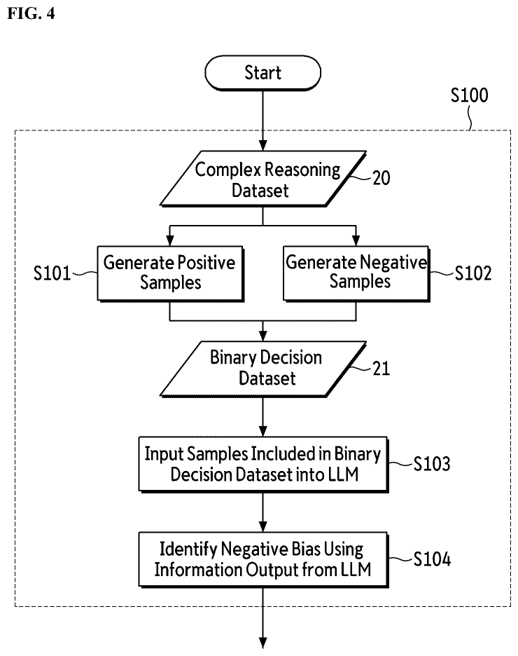

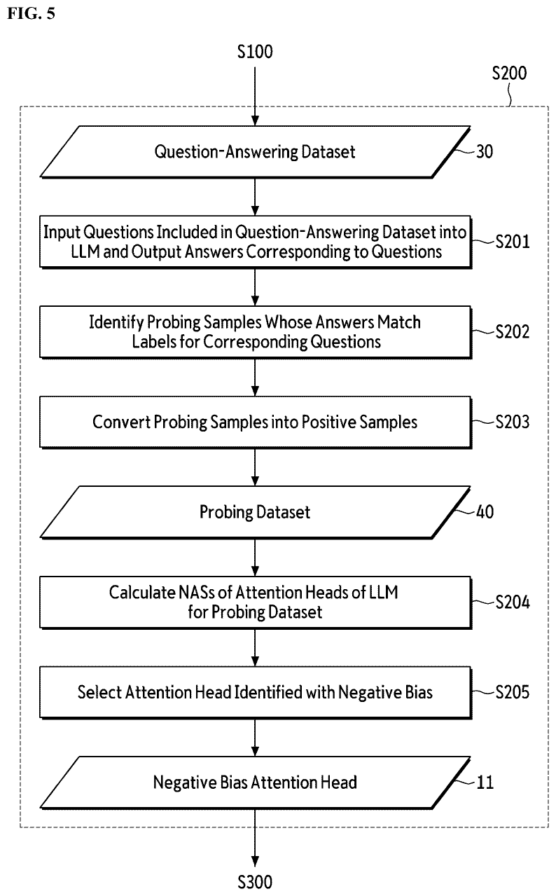

Embodiments of a process of identifying negative bias in the LLM 10 will hereinafter be described in detail with reference to FIG. 4.

FIG. 4 is a flowchart illustrating a process of identifying negative bias according to an embodiment of the present disclosure. Step S100 in FIG. 4 may correspond to step S100 in FIG. 3.

Referring to FIG. 4, a complex reasoning dataset 20 including complex reasoning data samples, each composed of a question 2c and a label 2d for the question 2c, may be acquired.

Among the complex reasoning data samples included in the complex reasoning dataset 20, positive samples may be generated by converting some complex reasoning data samples (S101), and negative samples may be generated by converting the remaining complex reasoning data samples (S102).

In step S101, a new question including the question 2c of each complex reasoning data sample and the label 2d for the question 2c may be generated, and positive samples each including the generated new question and a positive answer (e.g., “YES”) may be generated.

For example, in step S101, when the question and label of each complex reasoning data sample are configured as{question, label}={“question”, “label”}, the question and answer of the corresponding positive sample may be configured as {question, answer}={“{question} is the answer {label}?”, “YES”}.

That is, in step S101, positive samples having a positive answer as the correct answer and negative samples having a negative answer as the correct answer may be generated using the complex reasoning data samples.

Each complex reasoning data sample may further include a context 2b corresponding to the question 2c and the label 2d. In this case, in step S101, a new question including the question 2c, the label 2d, and the context 2b of each complex reasoning data sample may be generated, and positive samples each including the generated new question may be generated.

For example, in step S101, when the question, label, and context of each complex reasoning data sample are configured as {question, label, context}={“question”, “label”, “context”}, the question, label, and context of the corresponding positive sample may be configured as {question, answer}={“{context}{question} is the answer {label}?”, “YES”}.

In step S102, a corrupted label may be generated, a new question including the question 2c of each complex reasoning data sample and the corrupted label may be generated, and negative samples each including the generated new question and a negative answer (e.g., “NO”) may be generated.

In step S102, the corrupted label may be generated in answer to each complex reasoning data sample, using an LLM. In this case, the LLM, which is a language model for generating an answer to an input question, may be either the LLM 10 or another LLM.

The question 2c and the label 2d for the question 2c may be input to the LLM, and a corrupted label corresponding to the question 2c but differing from the label 2d may be generated. In this case, a command 2a giving instructions to generate a wrong answer to the question 2c may be input to the LLM together with the question 2c and the label 2d.

For example, in step S102, when the question, label, and context of each complex reasoning data sample are configured as {question, label, context}={“question”, “label”, “context”}, {“Referring the Context, contaminate the Answer to be wrong for the given Question. Question: {question} Context: {context} Answer: {label}”} may be input to the LLM, and as a result, a corrupted label {“corrupted label”} may be acquired from the LLM. In this example, the question and answer of the corresponding negative sample may be configured as {question, answer}={“{context}{question} Is the answer {corrupted label}?”, “NO”}.

A binary decision dataset 21, including the positive samples and negative samples generated from the respective complex reasoning data samples in steps S101 and S102, may be generated. The positive samples and negative samples included in the binary decision dataset 21 may be referred to as binary decision data samples.

The numbers of positive samples and negative samples included in the binary decision dataset 21 may be the same.

According to an embodiment of the present disclosure, the binary decision dataset 21 may be generated by converting complex reasoning data samples including various types of labels 2d for the question 2c into binary decision data samples that enable a positive or negative binary decision, and the performance of the LLM 10 in a binary decision task requiring complex reasoning may be evaluated using the generated binary decision dataset 21.

That is, in performing a task in which the LLM 10 determines whether the input question 2c is true or false and generates a positive or negative answer accordingly, it may be identified whether the LLM 10 has a negative bias that causes it to generate a negative answer for a sample whose correct answer is a positive answer.

The binary decision data samples included in the binary decision dataset 21 may be input to the LLM 10 (S103), and the negative bias of the LLM 10 may be identified using the information output from the LLM 10 (S104).

In other words, the negative bias of the LLM 10 may be identified using the information obtained as a result of inputting each of the positive samples and negative samples corresponding to the complex reasoning data samples included in the binary decision dataset 21 to the LLM 10.

In step S103, the question of each binary decision data sample included in the binary decision dataset 21 may be input to the LLM 10, and an answer 3 corresponding to the input question may be obtained from the LLM 10. In other words, the question of each binary decision data sample may be prompted to the LLM 10.

In this case, a command 2a giving instructions to respond with either a positive answer (e.g., “YES”) or a negative answer (e.g., “NO”) may be input to the LLM 10 together with the question of each binary decision data sample included in the binary decision dataset 21, and as a result, a positive or negative answer corresponding to the input question may be obtained from the LLM 10.

For example, when the question and answer of a binary decision data sample included in the binary decision dataset 21 are configured as {question, answer}={“{context}{question} is the answer {label}?”, “YES”}, in step S103, a prompt including “{context}{question} is the answer {label}?” may be input to the LLM 10.

In another example, when the question and answer of each binary decision data sample included in the binary decision dataset 21 are configured as {question, answer}={“{context}{question} Is the answer {corrupted label}?”, “NO”}, in step S103, a prompt including “{context}{question} Is the answer {corrupted label}?” may be input to the LLM 10.

In step S104, answers corresponding to respective binary decision data samples input to the LLM 10 may be obtained, and the obtained answers may be either positive (e.g., “YES”) or negative (e.g., “NO”).

Additionally, in step S104, the number of obtained answers from the LLM 10 that do not match the answers included in the respective binary decision data samples may be calculated.

For example, a prompt including the question of each positive sample may be input to the LLM 10, and a negative answer may be output from the LLM 10 accordingly. In another example, a prompt including the question of each negative sample may be input to the LLM 10, and a positive answer may be output from the LLM 10 accordingly.

That is, in step S104, the number of binary decision data samples for which the LLM 10 has output false answers may be calculated.

When the number of binary decision data samples for which false negative answers are obtained from the LLM 10 is greater than the number of binary decision data samples for which false positive answers are obtained from the LLM 10, the LLM 10 may be determined to exhibit negative bias. In this case, the numbers of positive samples and negative samples included in the binary decision dataset 21 may be the same.

According to some embodiments of the present disclosure, the binary decision dataset 21 is a dataset input to the LLM 10 to identify the negative bias of the LLM 10. Accordingly, when each of the positive samples and negative samples included in the binary decision dataset 21 is input to the LLM 10, a highly reliable negative bias determination result can be acquired only when the difficulty of determining whether the question of each positive sample is true and the difficulty of determining whether the question of each negative sample is false are consistent.

According to some embodiments of the present disclosure, when each complex reasoning data sample further includes a context 2b, a prompt 2 including the context 2b together with the question 2c and the label 2d may be input to the LLM for generating a corrupted label, and each negative sample included in the binary decision dataset 21 may be generated using the generated corrupted label.

Additionally, in step S104, a difference in probability assigned by the LLM 10 to each positive and/or negative answers may be calculated. When comparing the answers obtained by inputting each binary decision data sample to the LLM 10 with the answers included in the binary decision data samples, the greater the difference between the number of binary decision data samples for which false negative answers are obtained and the number of binary decision data for which false positive answers are obtained, or the greater the difference in probability between positive answers and negative answers, the greater the degree of negative bias exhibited by the LLM 10 may be determined to be.

An LLM 10 with a high degree of negative bias may be evaluated as a language model with low reliability, and the negative bias of the LLM 10 may be mitigated through fine-tuning according to some embodiments of the present disclosure.

An embodiment of a process of detecting an attention head with negative bias in the LLM 10, identified to have negative bias according to the embodiments described with reference to FIG. 4, will hereinafter be described in detail with reference to FIG. 5.

FIG. 5 is a flowchart illustrating a process of detecting an attention head with negative bias according to some embodiments of the present disclosure.

Steps S100, S200, and S300 in FIG. 5 may correspond to steps S100, S200, and S300 in FIG. 3, and step S100 in FIG. 5 may correspond to step S100 in FIG. 4.

Referring to FIG. 5, a question-answering dataset 30 including question-answering samples, each composed of a question 2c and a label 2d for the question 2c, may be acquired.

To identify probing samples from among the question-answering samples, the question 2c of each question-answering sample may be input to the LLM 10, and as a result, an answer 3 corresponding to the question 2c may be obtained from the LLM 10 (S201). In other words, the question of each of the question-answering samples may be input to the LLM 10, and answers corresponding to the respective questions may be obtained from the LLM 10.

Question-answering samples whose labels 2d match the answers 3 obtained by inputting their corresponding questions 2c may be identified as probing samples (S202).

Once the probing samples are identified based on the prior knowledge of the LLM 10, positive samples may be generated by converting the identified probing samples (S203).

It is to be noted that, even if not explicitly stated, the technical idea understood from the embodiments described with reference to FIG. 4, in which complex reasoning data samples are converted into binary decision data samples, may obviously be applicable to the conversion of the probing samples into positive samples, as performed in step S203.

In step S203, a new question including the question 2c of each probing sample and the label 2d for the question 2c may be generated, and positive samples each including the generated new question and a positive answer (e.g., “YES”) may be generated.

A probing dataset 40 including the positive samples corresponding to the respective probing samples may be generated.

A method for detecting an attention head 11 (hereinafter, a negative bias attention head 11) with negative bias using the probing dataset 40 including positive samples corresponding to the respective probing samples will hereinafter be described in detail.

First, a negative bias attention score (NAS) may be calculated for each of the attention heads of the LLM 10 for the probing dataset 40 (S204). Then, at least one negative bias attention head 11 may be selected from among the attention heads using the calculated NASs for the probing dataset 40 (S205).

Specifically, in step S204, a prompt 2 corresponding to each probing sample included in the probing dataset 40 may include a question prompt, which is the question of a corresponding probing sample converted into a positive sample, and a command 2a giving instructions to respond with either a positive answer (e.g., “YES”) or a negative answer (e.g., “NO”). In this case, the command 2a may be located to the left or before the question prompt within the prompt 2.

That is, in step S204, the prompt 2 is generated using the question of each probing sample converted into a positive sample (i.e., using the question prompt), such that the LLM 10 is instructed to respond with “YES.”

In step S204, a prompt 2 corresponding to each probing sample included in the probing dataset 40 may be input to the LLM 10, and as a result, an attention matrix for each of the attention heads for the prompt 2 may be acquired from the LLM 10.

The attention matrix is a matrix including attention weight values for respective tokens included in the prompt 2. In step S204, the attention matrix may include attention weights that tokens included in the question prompt of each probing sample converted into a positive sample apply to the tokens included in the command 2a.

In step S204, a NAS may be calculated for each attention head for each probing sample included in the probing dataset 40 using the attention matrix acquired from the LLM 10.

The NAS may be calculated for each attention head for each sample input to the LLM 10.

The NAS is calculated based on the ratio of the attention weight value of a token (hereinafter, a negative token) corresponding to a negative answer to the attention weight value of a token (hereinafter, a positive token) corresponding to a positive answer, among the tokens included in the prompt 2 input to the LLM 10.

For example, in step S204, when a command 2a, “You MUST answer Yes or No,” is included in the probing dataset 40 together with the question of each probing sample, the NAS for the corresponding probing sample may be calculated based on the ratio of the attention weight value of the negative token “NO” to that of the positive token “YES.”

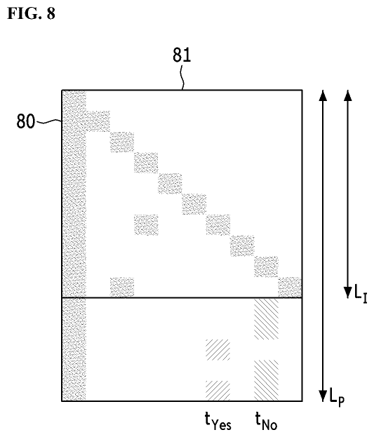

A specific illustrative example of how to calculate the NAS will be described later with reference to FIGS. 7 and 8.

In step S204, an average of the NASs of each attention head for the respective probing samples included in the probing dataset 40 may also be calculated.

In the present disclosure, for convenience of explanation, the average of the NASs of one attention head for respective samples included in a particular dataset is defined as a single-head NAS, and the average of such single-head NASs of respective attention heads for the particular dataset is defined as a model NAS.

In step S205, at least one negative bias attention head 11 may be selected using the NASs of the attention heads for the probing dataset 40.

In the present disclosure, the negative bias attention head 11 may refer to an attention head that gives a greater attention weight to either positive or negative tokens than to other tokens included in the prompt 2 input to the LLM 10, and gives a greater attention weight to a negative token than to a positive token.

In other words, the negative bias attention head 11 refers to an attention head whose single-head NAS is relatively higher than that of other attention heads consistently across the probing samples, when the prompt 2 is input to the LLM 10 using the question of each probing sample converted into a positive sample (i.e., using the question prompt), with instructions to respond with “YES.”

For example, when a prompt 2 that is to be responded to with “YES” is input to the LLM 10, a predefined number of attention heads with the highest single-head NASs may be selected as negative bias attention heads 11.

In another example, for each of the probing samples included in the probing dataset 40, k attention heads (where k denotes a predefined critical value) with the highest NASs may be selected first. That is, top-k attention heads with high NAS values may be selected for each probing sample. Then, among the top-k attention heads, an attention head that appears in the top k across a predetermined proportion or more of the probing samples may be selected as a negative bias attention head 11.

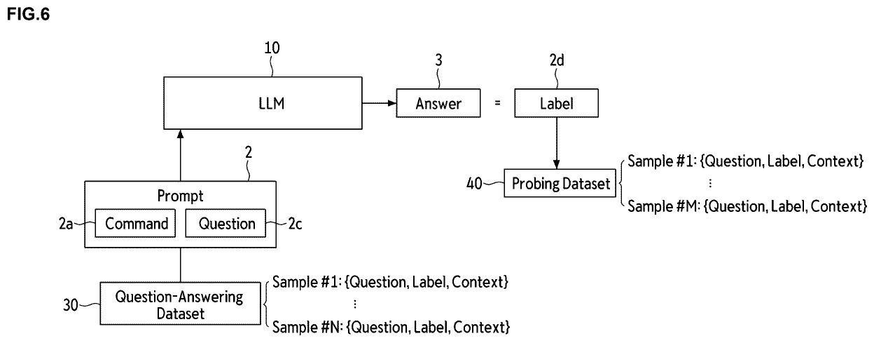

A method for identifying probing samples from among question-answering samples, as performed in steps S201 and S202, will hereinafter be described in detail with reference to FIG. 6.

FIG. 6 is a diagram for explaining a probing dataset according to some embodiments of the present disclosure.

A probing sample refers to a sample whose label 2d matches the answer 3 obtained by inputting its question 2c to the LLM 10, and may indicate a question-answering sample for which the LLM 10 knows the label 2d as the “correct answer” to the question 2c.

In order to detect a negative bias attention head 11 from the LLM 10 in which negative bias has been identified, it is necessary to observe cases where the LLM 10 generates an answer 3 other than the correct answer, for example, a negative answer, despite knowing the “correct answer” to the input question 2c, for example, a positive answer.

For example, as illustrated in FIG. 6, each question-answering sample may include a context 2b, a question 2c, and a label 2d. When an answer 3 obtained by inputting a prompt 2 including the question 2c to the LLM 10 matches the label 2d, the corresponding question-answering sample may be identified as a probing sample.

Here, even if the question-answering sample includes the context 2b, the context 2b may not be included in the prompt 2 in order to block the intervention of additional knowledge when the LLM 10 generates the answer 3.

Each question-answering sample identified as a probing sample and including the context 2b, question 2c, and label 2d may be included in the probing dataset 40.

Although not illustrated in FIG. 6 for convenience of explanation, the probing dataset 40 may include probing samples converted into positive samples according to some embodiments of the present disclosure, as described earlier with reference to FIG. 5.

Detailed descriptions of the attention heads in the LLM 10 and how to calculate the NASs of the attention heads in step S204 of FIG. 5 will hereinafter be described with reference to FIG. 7.

FIG. 7 is a diagram for explaining attention heads according to some embodiments of the present disclosure.

The LLM 10 may include a transformer generated by repeatedly stacking layers of the same structure, and an l-th layer included in the LLM 10 may include an attention module that performs self-attention.

The attention module may include a plurality of attention heads that assign attention weights to tokens included in the prompt 2.

Each attention head included in each layer of the LLM 10 may calculate an attention matrix one side of which has the length of an input sequence x during inference. In other words, as illustrated in FIG. 7, each attention head may calculate an attention matrix including attention weights for the respective tokens included in the prompt 2. Here, the attention matrix may be formed in a square form.

Assuming that the input sequence x (x={x₁, x₂, . . . , x_{N}}) input to the LLM 10, i.e., the prompt 2, includes a command 2a (I={I₁, I₂, . . . , I_{N}}) and a question prompt (P_{Q}={P_{Q}_{₁}, . . . , P_{Q}_{_{M}}}) in series, the attention module that performs self-attention may include linear projection layers W_{q}, Wₖ, and Wᵥ that map the input sequence x to a question q, a key k, and a value v, respectively. The attention module may calculate the question q, key k, and value v for self-attention using the following equations:

$$q = {W}_{q} * x , k = {W}_{k} * x , and v = {W}_{v} * x .$$

When the number of attention heads included in the attention module is H, W_{q}, Wₖ, and Wᵥ have dimensions of [symbol] where D_{hidden} is the number of hidden dimensions of x, and D_{head} is the number of hidden dimensions of q, k, and v in each attention head.

Here, numbers H_{q} and Hₖ of attention heads assumed in W_{q} and Wₖ may differ. In this case, Wₖ may be constructed by repeating its dimensions H_{q}/Hₖ times so as to match [symbol] .

In this case, the parameters involved in the question calculation for an h-th attention head in the l-th layer correspond to a submatrix W_{q}[(h−1)*D_{head}:h*D_{head}, ·].

Therefore, the h-th attention head in the l-th layer may map the input sequence x to a matrix-type question Q^{I,h}, a matrix-type key K^{l,h}, and a matrix-type value V^{l,h}. The h-th attention head in the l-th layer may calculate an attention matrix A^{l,h} including attention weights for the respective tokens in the input sequence x and may generate a matrix, as defined by the following equation, as the result of a self-attention operation:

$$softmax ( \frac{( {Q}^{l , h} \cdot {( {K}^{l , h} )}^{T} )}{\sqrt{{D}_{head}}} ) \cdot {V}^{l , h} = {A}^{l , h} \cdot {V}^{l , h} .$$

The tokens included in the prompt 2 may refer to words included in the prompt 2.

At this time, the tokens included in the prompt 2 are arranged sequentially in the prompt 2, and may attend only to tokens located to their left. In other words, as illustrated in FIG. 7, when the command 2a and the question prompt are arranged in the order of {command, question prompt} in the prompt 2, the tokens in the question prompt may attend to the tokens included in the command 2a.

Accordingly, as depicted in FIG. 7, each attention head may calculate the attention weights that the question prompt applies to the tokens included in the command 2a.

For example, when the prompt 2 includes a command 2a configured as {“ . . . You WUST answer Yes or No . . . ”}, the words {“You” }, {“WUST”}, {“answer”}, {“YES”}, {“or”}, and {“No”} included in the command 2a may be identified as six tokens t₁ through t₆, and the attention weights that the question prompt applies to the tokens t₁ through t₆, respectively, may be calculated.

A detailed description of how to calculate NAS using the attention matrix of an attention head will hereinafter be described.

An NAS according to the present disclosure may be defined by the following formula.

When the input sequence x (i.e., the prompt 2) is input to the LLM 10, an NAS

$${NAS}_{x}^{l , h}$$

of the h-th attention head in the l-th layer of the LLM 10 may be defined as follows:

$${NAS}_{x}^{l , h} := {\sum }_{i = {L}_{I}}^{{L}_{P}} ( {A}_{i , {t}_{Yes}}^{l , h} + {A}_{i , {t}_{No}}^{l , h} ) * log ( \frac{{A}_{i , {t}_{No}}^{l , h}}{{A}_{i , {t}_{Yes}}^{l , h}} ) .$$

Here, L_{I} and L_{P} denote the length of the command 2a and the length of the prompt 2, respectively,

$${A}_{i , j}^{l , h}$$

is the value at an i-th row and a j-th column of the attention matrix inferred by the h-th attention head in the l-th layer, and t_{Yes} and t_{No} denote the indices representing the positions of a positive token and a negative token, respectively, within the command 2a.

FIG. 8 is a diagram for explaining attention weights applied to tokens included in a prompt input to an LLM according to some embodiments of the present disclosure.

Specifically, FIG. 8 illustrates an exemplary attention matrix inferred by a negative bias attention head 11 for a prompt 2 including a command 2a and a question prompt.

Referring to FIG. 8, a vertical axis 80 represents tokens included in the prompt 2 that receive attention (or are to be attended), and a horizontal axis 81 represents tokens included in the prompt 2 that give attention (or are to attend).

In other words, the vertical axis 80 represents tokens included in a question prompt that attend to the tokens in the command 2a, and the horizontal axis 81 represents the tokens included in the command 2a, including the positive token t_{Yes} and the negative token t_{No}.

According to some embodiments of the present disclosure, the negative bias attention head 11 calculates a greater attention weight for the negative token t_{No} than for the positive token t_{Yes} among the tokens included in the prompt 2.

Accordingly, in some embodiments of the present disclosure, the negative bias attention head 11 may be detected based on its NAS, calculated based on the ratio of the attention weight of the negative token t_{No} to that of the positive token t_{Yes}.

For example, when the prompt 2 includes a command 2a configured as {“You MUST answer Yes or No”} and a question prompt including, as a question prompt, a probing sample question configured as {“{question} is the answer {label}?”}, the attention matrix inferred by the negative bias attention head 11 may show, as illustrated in FIG. 8, that the attention weight for a negative token {“No”}(t_{yes}) is greater than that for a positive token {“YES”}(t_{No}).

An illustrative example of a process of generating data for fine-tuning a negative bias attention head 11 selected according to the embodiment described with reference to FIG. 5 will hereinafter be described.

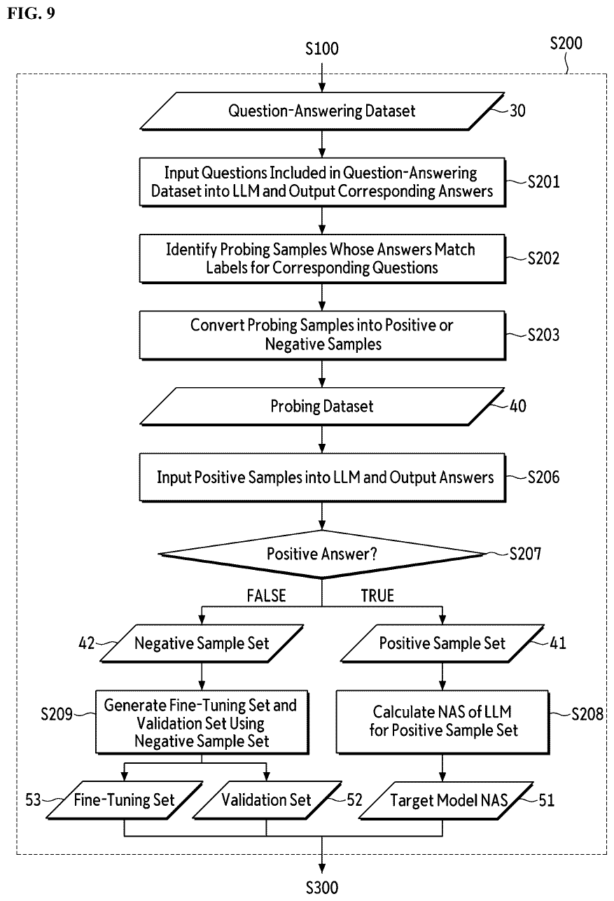

FIG. 9 is a flowchart illustrating a process of generating data for fine-tuning a negative bias attention head 11 according to some embodiments of the present disclosure.

Steps S100, S200, and S300 in FIG. 9 may correspond to steps S100, S200, and S300 in FIG. 3.

In addition, steps S201 through S203 in FIG. 9 may correspond to steps S201 through S203 in FIG. 5, and steps S206 through S209 in FIG. 9 may be performed concurrently with steps S204 and S205 in FIG. 5.

Referring to FIG. 9, in steps S201 through S203, probing samples may be identified from among the question-answering samples included in a question-answering dataset, the identified probing samples may be converted into positive samples, and a probing dataset 40 including the positive samples may be generated.

For convenience of explanation, each probing sample converted into a positive sample will hereinafter be referred to as a converted probing sample.

In steps S206 and S207, the converted probing samples included in the probing dataset 40 may be divided into a positive sample set 41 and a negative sample set 42.

Here, the positive sample set 41 includes converted probing samples for which the corresponding answers 3 obtained from the LLM 10 match a positive answer (e.g., “YES”), and the negative sample set 42 includes converted probing samples for which the corresponding answers 3 output from the LLM 10 match a negative answer (e.g., “NO”).

In step S206, the questions of the converted probing samples included in the probing dataset 40 may be input to the LLM 10, and answers corresponding to the questions of the converted probing samples may be obtained from the LLM 10.

In step S207, if the positive answers of the converted probing samples match the corresponding answers 3 acquired from the LLM 10, the converted probing samples are included in the positive sample set 41, and otherwise, the converted probing samples are included in the negative sample set 42.

In other words, when a prompt 2 including the question (i.e., question prompt) of each converted probing sample for which the LLM 10 should output a positive answer as the correct answer is input to the LLM 10 the positive sample set 41 may be generated for cases where the LLM 10 outputs a true answer 3, and the negative sample set 42 may be generated for cases where the LLM 10 outputs a false answer 3.

The single-head NASs of the attention heads of the LLM 10 for the positive sample set 41 are calculated first, and then, the model NAS of the attention heads of the LLM 10 for the positive sample set 41 is calculated by averaging the calculated single-head NASs (S208).

For example, the single-head NASs of the attention heads of the LLM 10 for a first positive sample included in the positive sample set 41 may be calculated, and the average of the calculated single-head NASs may be calculated as the model NAS of the attention heads of the LLM 10 for the first positive sample.

The model NAS for the positive sample set 41, calculated in step S208, may be used as a reference value for determining the termination of a fine-tuning process for the LLM 10 identified to exhibit negative bias.

For example, when there are multiple positive samples included in the positive sample set 41, multiple model NASs may be calculated for the respective positive samples in step S208. In this case, one of the multiple model NASs may be used as the reference for determining the termination of the fine-tuning process.

For convenience of explanation, the model NAS for the positive sample set 41 used as the reference for determining the termination of the fine-tuning process will hereinafter be referred to as a target model NAS 51.

For example, a minimum model NAS from among the multiple model NANs calculated for the positive sample set 41 in step S208 may be determined as the target model NAS 51.

A fine-tuning set 53, including fine-tuning samples to be used for fine-tuning the LLM 10 identified to have negative bias, and a validation set 52, including validation samples to be used for validating the fine-tuned LLM 10, may be generated from the negative sample set 42 (S209).

For example, in step S209, a fine-tuning set 53, including some of the samples included in the negative sample set 42, and a validation set 52, including the rest of the samples in the negative sample set 42, may be generated.

An embodiment of a process of fine-tuning one or more negative bias attention heads 11, selected according to the embodiments described with reference to FIG. 5, using the data (e.g., the target model NAS 51, the validation set 52, and/or the fine-tuning set 53) generated according to the embodiments described with reference to FIG. 9, will hereinafter be described.

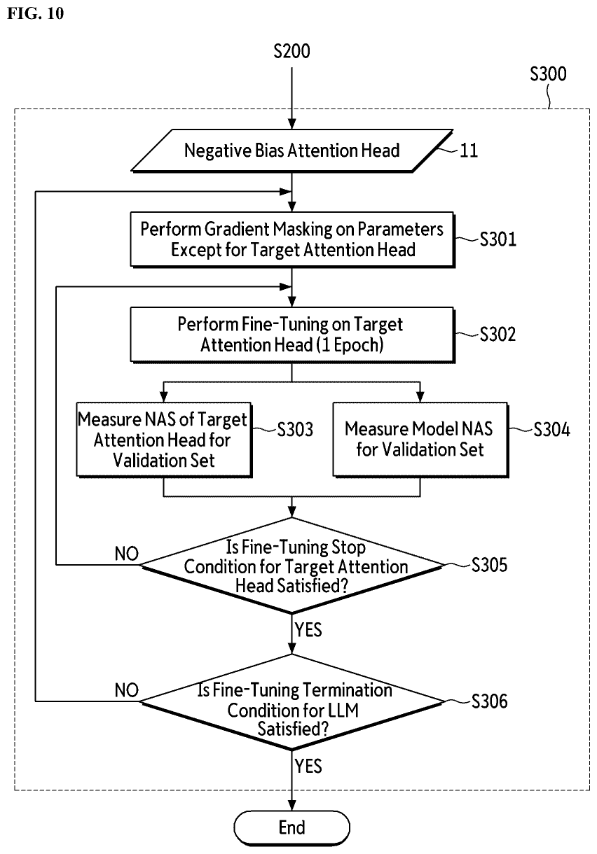

FIG. 10 is a flowchart illustrating a process of fine-tuning a negative bias attention head 11 according to some embodiments of the present disclosure.

According to some embodiments of the present disclosure, at least one negative bias attention head may be detected/selected from among the attention heads included in the LLM 10 identified to exhibit negative bias.

FIG. 10 illustrates an exemplary process of fine-tuning multiple negative bias attention heads when multiple attention heads are detected/selected as negative bias attention heads 11 from among the attention heads of the LLM 10.

The fine-tuning priority of multiple negative bias attention heads 11 may be determined in descending order of their single-head NASs for the probing dataset 40 including the converted probing samples.

For example, although not illustrated in FIG. 10, the multiple negative bias attention heads 11 may be sorted in descending order of their single-head NASs for the probing dataset 40 and fine-tuned in that order.

In the following description, a target attention head refers to a negative bias attention head 11 to be fine-tuned and may correspond to any one of the multiple negative bias attention heads 11.

First, gradient masking may be performed on the parameters of the LLM 10 except for those of the target attention head to be fine-tuned (S301).

Then, fine-tuning may be performed on the target attention head (S302).

The target attention head may be fine-tuned by repeatedly updating its parameters in units of epochs.

In one epoch iteration, the parameters of the target attention head may be updated as follows.

First, a prompt 2 may be generated, including the question (i.e., question prompt) of each fine-tuning sample included in the fine-tuning set 53 and a command 2a giving instructions to respond with either a positive answer (e.g., “YES”) or a negative answer (e.g., “NO”).

Then, by training the target attention head on the fine-tuning samples included in the fine-tuning set 53, the parameters of the target attention head may be updated to maximize the log-likelihood for the positive token included in the prompt 2.

In addition, after the parameter update for the target attention head in each epoch iteration, the single-head NAS of the target attention head for the validation set 52 may be calculated (S303), and the model NAS for the validation set 52 may also be calculated (S304).

The repeated parameter updates of the target attention head per epoch may be terminated when a fine-tuning stop condition is satisfied (S305).

The fine-tuning stop condition may include a condition (hereinafter, Condition 1) in which the parameter update of the target attention head is stopped when the calculated single-head NAS or model NAS increases compared to their respective previous counterparts.

For example, if the single-head NAS or model NAS calculated in step S303 or S304 exceeds its counterpart from the previous epoch iteration, the parameter update of the target attention head may be stopped.

The fine-tuning stop condition may further include a condition (hereinafter, Condition 2) in which the parameter update of the target attention head is stopped when the calculated single-head NAS fall below a predetermined threshold.

For example, if the single-head NAS calculated in step S303 or the model NAS calculated in step S304 is lower than a predetermined threshold (e.g., 0.5), the parameter update of the target attention head may be stopped.

The fine-tuning stop condition may include both Condition 1 and Condition 2, and the fine-tuning of the target attention head may be stopped if either Condition 1 or Condition 2 is satisfied.

Additionally, although not illustrated in FIG. 10, if Condition 1 and/or Condition 2 are satisfied in step S305 and a rollback condition is met, the parameters of the updated target attention head may be restored to their pre-update state.

That is, in step S305, when Condition 1 and/or Condition 2 are satisfied, it may be determined whether the rollback condition is met. Then, if the rollback condition is determined to be met, the parameter update of the target attention head may be canceled.

Before the training of the target attention head begins, the single-head NAS and/or model NAS for the validation set 52 may be calculated. In other words, the single-head NAS and/or model NAS of the target attention head for the validation set 52 may be calculated based on the initial parameter state before any parameter update conducted by performing steps S301 through S305 iteratively.

The rollback condition may include a condition (hereinafter, Condition 3) in which the parameter update of the target attention head is canceled if either the single-head NAS or model NAS calculated immediately before stopping the fine-tuning process exceeds the single-head NAS or model NAS calculated in the initial parameter state.

For example, after updating the parameters of the target attention head in epoch #1, the parameters of the target attention head may be updated again in epoch #2.

In this example, if Condition 1 and/or Condition 2 are satisfied after the re-update in epoch #2, and the single-head NAS and/or model NAS of the target attention head for the validation set 52, calculated in step S303, are higher than their respective counterparts from the initial parameter state, the parameters of the target attention head may be restored from epoch #2 to epoch #1. If the fine-tuning stop condition for the target attention head is not satisfied in step S305, the target attention head may continue to be updated by learning the fine-tuning samples included in the fine-tuning set 53.

If the fine-tuning stop condition for the target attention head is satisfied in step S305, fine-tuning of the target attention head may be terminated, and the subsequent negative bias attention head 11 in priority may be fine-tuned as a new target attention head.

For example, if the first attention head in priority among the multiple negative bias attention heads is fine-tuned as the target attention head according to the embodiments described with regard to steps S301 through S305, and the fine-tuning for the first attention head is terminated, the second attention head in priority may be fine-tuned as a new target attention head according to the embodiments described with regard to steps S301 through S305.

If the fine-tuning stop condition for the target attention head is satisfied in step S305, fine-tuning of the multiple negative bias attention heads 11 in the LLM 10 may be stopped when a fine-tuning termination condition for the LLM 10 is satisfied (S306).

If the fine-tuning termination condition for the LLM 10 is not satisfied in step S306, the fine-tuning of the target attention head may be terminated, and the subsequent negative bias attention head 11 in priority may be fine-tuned as a new target attention head.

For example, if the first attention head in priority among the multiple negative bias attention heads 11 is fine-tuned as the target attention head according to the embodiments described with regard to steps S301 through S305, and the fine-tuning stop condition for the first attention head is satisfied, the fine-tuning for the first attention head may be terminated. Then, if the fine-tuning stop condition for the first attention head is satisfied, but the fine-tuning termination condition for the LLM 10 is not met, the second attention head in priority among the multiple negative bias attention heads 11 may be fine-tuned as a new target attention head according to the embodiments described with regard to steps S301 through S305.

In another example, if the first attention head is fine-tuned as the target attention head according to the embodiments described with regard to steps S301 through S305 and its fine-tuning is stopped, and the fine-tuning stop condition for the first attention head is satisfied, the fine-tuning for the first attention head may be terminated. Then, if the fine-tuning stop condition for the first attention head is satisfied, and the fine-tuning termination condition for the LLM 10 is met, the fine-tuning process for the entire LLM 10 may be terminated without further fine-tuning the subsequent negative bias attention heads 11 in priority.

The fine-tuning termination condition for the LLM 10 may include a condition (Condition 4) in which the entire fine-tuning process for the LLM 10 is terminated if the model NAS for the validation set 52 is less than the target model NAS 51 corresponding to the model NAS for the positive sample set 41, described with reference to FIG. 9.

Condition 4 may be determined to be satisfied when the model NAS for the validation set 52, calculated in the last epoch iteration during the fine-tuning of the target attention head, is lower than the target model NAS 51.

For example, if the model NAS for the validation set 52, calculated in step S304, is lower than the target model NAS 51, the entire fine-tuning process for the LLM 10 may be terminated.

Additionally, the fine-tuning termination condition for the LLM 10 may include a condition (Condition 5) in which the entire fine-tuning process for the LLM 10 is terminated if fine-tuning for all the multiple negative bias attention heads 11 included in the LLM 10 is completed.

For example, according to some embodiments of the present disclosure, if k negative bias attention heads are detected/selected from among the attention heads included in the LLM 10, and all the k negative bias attention heads 11 are fine-tuned by repeating steps S301 through S306 k times, the entire fine-tuning process for the LLM 10 may be terminated.

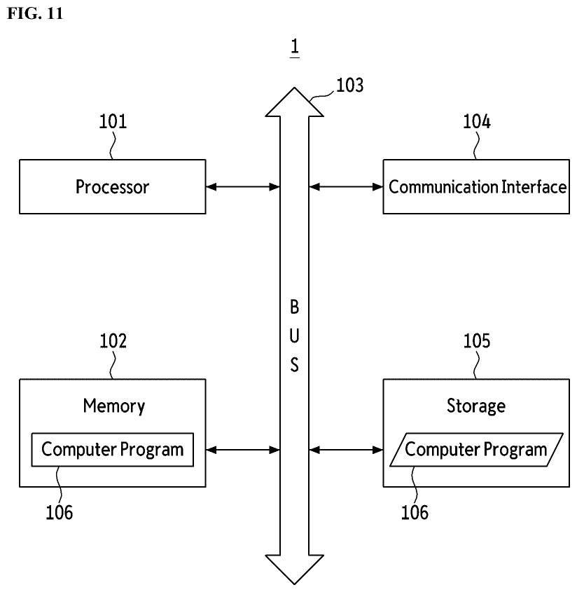

FIG. 11 is an illustrative hardware configuration diagram illustrating the computing device 1.

Referring to FIG. 11, the computing device 1 may include at least one processor 101, a system bus 103, a communication interface 104, a memory 102, which loads a computer program 106 executed by the processor 101, and a storage 105, which stores the computer program 106. Even though FIG. 11 depicts only components related to the embodiments of the present disclosure, it is obvious to one of ordinary skill in the art to which the present disclosure pertains that the computing device 1 may further include other generic components, in addition to the components depicted in FIG. 11. Moreover, in some embodiments, the computing device 1 may be configured with some of the components depicted in FIG. 11 omitted. The components of the computing device 1 will hereinafter be described.

The processor 101 may control the overall operation of each of the components of the computing device 1. The processor 101 may be configured to include at least one of a central processing unit (CPU), a micro-processor unit (MPU), a micro-controller unit (MCU), a graphics processing unit (GPU), Neural Processing Unit (NPU) or any form of processor well-known in the field of the present disclosure. Additionally, the processor 101 may perform computations for at least one application or program to execute operations/methods according to some embodiments of the present disclosure. The computing device 1 may be equipped with one or more processors.

In Addition, the computing device 1 may further include database, and the processor 101 may store data and/or information generated/output according to some embodiments of the present disclosure in the memory 102 and/or a database. Here, the database in which the data and/or information is stored is not limited to the database included in the computing device 1, and may include, for example, a database of external server.

The memory 102 may store various data, commands, and/or information. The memory 102 may load the computer program 166 from the storage 105 to execute the operations/methods according to some embodiments of the present disclosure. The memory 102 may be implemented as a volatile memory such as a random-access memory (RAM), but the present disclosure is not limited thereto.

The bus 103 may provide communication functionality between the components of the computing device 1. The bus 103 may be implemented in various forms such as an address bus, a data bus, and a control bus.

The communication interface 104 may support wired or wireless Internet communication of the computing device 1. Additionally, the communication interface 104 may also support various other communication methods. To this end, the communication interface 104 may be configured to include a communication module well-known in the technical field of the present disclosure.

The storage 105 may non-transitorily store at least one computer program 106. The storage 105 may be configured to include a non-volatile memory such as a read-only memory (ROM), an erasable programmable ROM (EPROM), an electrically erasable programmable ROM (EEPROM), a flash memory, as well as a computer-readable recording medium (e.g., non-transitory recording medium) in any form well-known in the technical field of the present disclosure, such as a hard disk or a removable disk.

The computer program 106, when loaded into the memory 102, may include one or more instructions that enable the processor 101 to perform the operations/methods according to some embodiments of the present disclosure. That is, by executing the loaded one or more instructions, the processor 101 may perform the operations/methods according to some embodiments of the present disclosure.

For example, the computer program 106 may include instructions to: convert each of a first plurality of samples from among samples included in a first dataset, into a positive sample including a positive answer, each of the first plurality of samples including a question and a label for the question; convert each of a second plurality of samples, which are the remaining samples included in the first dataset excluding the first plurality of samples, into a negative sample including a negative answer; generate a second dataset including the positive samples corresponding to the first plurality of samples and the negative samples corresponding to the second plurality of samples; input the positive samples and negative samples included in the second dataset into a first LLM, the first LLM being a language model configured to generate an answer to a question; and identify negative bias of the first LLM using information output from the first LLM.

In another example, the computer program 106 may include instructions to: acquire a first dataset including samples, each sample including a question and a label for the question; identify probing samples from among the samples included in the first dataset, wherein the probing samples are samples whose labels match the answers obtained by inputting their corresponding questions to an LLM; convert each of the probing samples into a positive sample; generate a second dataset including the positive samples corresponding to the probing samples; calculate the first NASs of a plurality of attention heads of the LLM for the second dataset; select one or more attention heads from among the plurality of attention heads of the LLM, using the first NASs; and perform fine-tuning on the at least one selected attention head.

According to some embodiments of the present disclosure, complex reasoning data samples that include various forms of answers to a question may be converted into binary decision data samples that enable a binary determination of either positive or negative, and the negative bias of the LLM may be identified using the binary decision data samples.

According to some embodiments of the present disclosure, negative bias of the LLM may be identified using a binary decision dataset converted from a complex reasoning dataset. Accordingly, negative bias occurring during a task where the LLM determines the truth or falsehood of a question may be identified.

According to some embodiments of the present disclosure, fine-tuning may be performed on the attention heads of an LLM identified to exhibit negative bias using a dataset generated based on prior knowledge of the LLM, thereby mitigating hallucinations in the LLM. As a result, a more reliable language model may be developed.

Various embodiments of the present disclosure and their effects have been described so far with reference to FIGS. 1 through 11.

It should be noted that the effects of the present disclosure are not limited to those described above, and other effects of the present disclosure will be apparent from the following description.

The effects according to the technical idea of the present disclosure are not limited to those mentioned above, and other effects not discussed may be clearly understood by those skilled in the art from the following description.

The technical idea of the present disclosure described so far can be implemented as computer-readable code on a computer-readable medium. The computer program recorded on the computer-readable recording medium may be transmitted over a network, such as the Internet, to other computing devices where it can be installed and used.

Although operations are illustrated in a specific order in the drawings, it should not be understood that the operations need to be executed in the specific order shown or in sequential order, or that all illustrated operations need to be executed to obtain desired results. In certain circumstances, multitasking and parallel processing may be advantageous. In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation. cm What is claimed is:

1. A method for identifying negative bias, performed by a computing system, comprising:
converting each of a first plurality of samples, from among samples included in a first dataset, into a positive sample including a positive answer, each of the samples including a question and a label for the question;
converting each of a second plurality of samples, which are remaining samples excluding the first plurality of samples, into a negative sample including a negative answer;
generating a second dataset including positive samples corresponding to the first plurality of samples and negative samples corresponding to the second plurality of samples;
inputting the positive samples and the negative samples included in the second dataset into a first large language model (LLM), the first LLM being a language model configured to generate an answer to the question; and
identifying negative bias of the first LLM using information output from the first LLM.

2. The method of claim 1, wherein the converting of each of the first plurality of samples into the positive sample including the positive answer comprises:
generating a second question including a first question of a first sample among the first plurality of samples and a first label for the first question; and
generating a positive sample corresponding to the first sample, the generated positive sample including the second question and the positive answer.

3. The method of claim 1, wherein the converting of each of the second plurality of samples into the negative sample including the negative answer comprises:
generating a corrupted first label;
generating a second question including a first question of a first sample among the second plurality of samples and the corrupted first label; and
generating a negative sample corresponding to the first sample, the generated negative sample including the second question and the negative answer.

4. The method of claim 3, wherein the generating of the corrupted first label comprises:
inputting the first question and a first label of the first sample into a second LLM, the second LLM being a language model configured to generate an answer to the first question that differs from the first label; and
generating the corrupted first label, which differs from the first label, using information output from the second LLM.

5. The method of claim 1, wherein the identifying of the negative bias of the first LLM using the information output from the first LLM comprises:
acquiring answers corresponding to the respective positive samples and negative samples from the first LLM;
calculating a number of answers, among the acquired answers, that do not match the answers of corresponding samples; and
identifying the negative bias using the calculated number.

6. A method for mitigating negative bias in a large language model (LLM), performed by a computing system, comprising:
acquiring a first dataset including samples, each of the samples including a question and a label for the question;
identifying probing samples from among the samples included in the first dataset, the probing samples being samples whose labels match answers obtained by inputting corresponding questions to the LLM;
converting each of the probing samples into a positive sample;
generating a second dataset including positive samples corresponding to the probing samples;
calculating first negative bias attention scores (NASs) of a plurality of attention heads of the LLM for the second dataset;
selecting one or more attention heads from among the plurality of attention heads of the LLM using the first NASs; and
performing a fine-tuning process on the selected one or more attention heads.

7. The method of claim 6, wherein the converting of each of the probing samples into the positive sample comprises:
generating a second question including a first question of a first sample among the probing samples and a first label for the first question; and
generating a positive sample corresponding to the first sample, the generated positive sample including the second question and a positive answer.

8. The method of claim 6, wherein
the calculating of the first NASs of the plurality of attention heads of the LLM for the second dataset comprises:
inputting a prompt corresponding to a first sample among the positive samples included in the second dataset to the LLM;
acquiring, from the LLM, attention matrices of the plurality of attention heads for the prompt, each of the attention matrices including attention weight values for respective tokens included in the prompt; and
calculating first NASs of the plurality of attention heads for the first sample using the attention matrices,
the prompt includes a positive token and a negative token, and
each of the first NASs is calculated based on a ratio of an attention weight value for the negative token to an attention weight value for the positive token.

9. The method of claim 6, wherein the calculating of the first NASs of the plurality of attention heads of the LLM for the second dataset comprises:
calculating first NASs of a first attention head among the plurality of attention heads for the respective positive samples included in the second dataset; and
calculating an average of the calculated first NASs.

10. The method of claim 6, further comprising:
dividing the positive samples included in the second dataset into a first sample set and a second sample set;
calculating second NASs of the plurality of attention heads of the LLM for the first sample set;
calculating an average of the second NASs of the plurality of attention heads;
generating a fine-tuning set including a subset of samples included in the second sample set; and
generating a validation set including remaining samples in the second sample set excluding the subset of samples,
wherein the fine-tuning process is performed using the average of the second NASs, the fine-tuning set, and the validation set.

11. The method of claim 10, wherein the performing of the fine-tuning process on the selected one or more attention heads comprises:
repeatedly updating parameters of a first attention head among the selected one or more attention heads using the fine-tuning set;
calculating a third NAS of the first attention head for the validation set;
terminating the updating of the parameters of the first attention head if the third NAS is lower than a predefined threshold;
calculating an average of third NASs of the plurality of attention heads for the validation set; and
terminating the fine-tuning process if the average of the third NASs is less than the average of the second NASs.

12. The method of claim 10, wherein the performing of the fine-tuning process on the selected one or more attention heads comprises:
in a first iteration, updating parameters of a first attention head among the selected one or more attention heads using the fine-tuning set;
calculating a third NAS of the updated first attention head for the validation set, and calculating an average of third NASs of the plurality of attention heads for the validation set;
in a second iteration after the first iteration, re-updating the parameters of the updated first attention head using the fine-tuning set;
calculating a fourth NAS of the re-updated first attention head for the validation set, and calculating an average of fourth NASs of the plurality of attention heads for the validation set; and
updating parameters of a second attention head among the selected one or more attention heads if the fourth NAS of the re-updated first attention head is higher than or equal to the third NAS of the updated first attention head or the average of the fourth NASs of the plurality of attention heads is greater than or equal to the average of the third NASs of the plurality of attention heads.

13. A system for identifying negative bias, comprising:
at least one processor; and
at least one memory storing instructions which, when executed by the at least one processor, cause the at least one processor to perform operations,
wherein the operations comprise:
converting each of a first plurality of samples, from among samples included in a first dataset, into a positive sample including a positive answer, each of the samples including a question and a label for the question;
converting each of a second plurality of samples, which are remaining samples excluding the first plurality of samples, into a negative sample including a negative answer;
generating a second dataset including positive samples corresponding to the first plurality of samples and negative samples corresponding to the second plurality of samples;
inputting the positive samples and the negative samples included in the second dataset into a first large language model (LLM), the first LLM being a language model configured to generate an answer to the question; and
identifying negative bias of the first LLM using information output from the first LLM.

14. The system of claim 13, wherein the converting of each of the second plurality of samples into the negative sample including the negative answer comprises:
generating a corrupted first label;
generating a second question including a first question of a first sample among the second plurality of samples and the corrupted first label; and
generating a negative sample corresponding to the first sample, the generated negative sample including the second question and the negative answer.

15. The system of claim 14, wherein the generating of the corrupted first label comprises:
inputting the first question and a first label of the first sample into a second LLM, the second LLM being a language model configured to generate an answer to the first question that differs from the first label; and
generating the corrupted first label, which differs from the first label, using information output from the second LLM.

16. A system for mitigating negative bias, comprising:
at least one processor; and
at least one memory storing instructions which, when executed by the at least one processor, cause the at least one processor to perform operations,
wherein the operations comprise:
acquiring a first dataset including samples, each of the samples including a question and a label for the question;
identifying probing samples from among the samples included in the first dataset, the probing samples being samples whose labels match answers obtained by inputting corresponding questions to a large language model (LLM);
converting each of the probing samples into a positive sample;
generating a second dataset including positive samples corresponding to the probing samples;
calculating first negative bias attention scores (NASs) of a plurality of attention heads of the LLM for the second dataset;
selecting one or more attention heads from among the plurality of attention heads of the LLM using the first NASs; and performing a fine-tuning process on the selected one or more attention heads.

17. The system of claim 16, wherein
the calculating of the first NASs of the plurality of attention heads of the LLM for the second dataset comprises:
inputting a prompt corresponding to a first sample among the positive samples included in the second dataset to the LLM;
acquiring, from the LLM, attention matrices of the plurality of attention heads for the prompt, each of the attention matrices including attention weight values for respective tokens included in the prompt; and
calculating first NASs of the respective attention heads for the first sample using the attention matrices,
the prompt includes a positive token and a negative token, and
each of the first NASs is calculated based on a ratio of an attention weight value for the negative token to an attention weight value for the positive token.

18. The system of claim 16, wherein
the operations further comprise:
dividing the positive samples included in the second dataset into a first sample set and a second sample set;
calculating second NASs of the plurality of attention heads of the LLM for the first sample set; calculating an average of the second NASs of the plurality of attention heads;
generating a fine-tuning set including a subset of samples included in the second sample set; and
generating a validation set including remaining samples in the second sample set excluding the subset of samples, and
the fine-tuning process is performed using the average of the second NASs, the fine-tuning set, and the validation set.

19. The system of claim 18, wherein the performing of the fine-tuning process on the selected one or more attention heads comprises:
repeatedly updating parameters of a first attention head among the selected one or more attention heads using the fine-tuning set;
calculating a third NAS of the first attention head for the validation set;
terminating the updating of the parameters if the third NAS is lower than a predefined threshold;
calculating an average of third NASs of the plurality of attention heads for the validation set; and
terminating the fine-tuning process if the average of the third NASs is lower than the average of the second NASs.

20. The system of claim 18, wherein the performing of the fine-tuning process on the selected one or more attention heads comprises:
in a first iteration, updating parameters of a first attention head among the selected one or more attention heads using the fine-tuning set;
calculating a third NAS of the updated first attention head for the validation set, and calculating an average of third NASs of the plurality of attention heads for the validation set;
in a second iteration after the first iteration, re-updating the parameters of the updated first attention head using the fine-tuning set;
calculating a fourth NAS of the re-updated first attention head for the validation set, and calculating an average of fourth NASs of the plurality of attention heads for the validation set; and
updating parameters of a second attention head among the selected one or more attention heads if the fourth NAS of the re-updated first attention head is higher than or equal to the third NAS of the updated first attention head or the average of the fourth NASs is greater than or equal to the average of the third NASs.
